(19) United States
(12) Patent Application Publication
(10) Pub. No.: US 2008/0170176 A1
(43) Pub. Date: Jul. 17, 2008

(54) Backlight Module Having Phosphor Layer and Liquid Crystal Display Device Using the Same

(75) Inventor: Yuh-Ren Shen, Tainan City (TW)

Correspondence Address: WPAT, PC;INTELLECTUAL PROPERTY ATTORNEYS, 2030 MAIN STREET, SUITE 1300, IRVINE, CA, 92614, US

(73) Assignee: VASTVIEW TECHNOLOGY INC., Hsinchu (TW)

(21) Appl. No.: 11/621,999

(22) Filed: Jan. 11, 2007

(51) Int. Cl. G02F 1/1335; F21V 9/16

(52) U.S. Cl. 349/64; 362/84

(57) ABSTRACT

There is provided a backlight module having a phosphor layer and a liquid crystal display device using the backlight module as its light source. The backlight module includes a bottom cover, a plurality of light sources (which can emit a blue light or an ultraviolet light) installed inside of the bottom cover, a diffusion plate, and a multicolor phosphor layer formed on a surface of the diffusion plate, wherein the phosphor consisting of the fluorescent materials can be excited by the blue light or the ultraviolet light, and the excited phosphor states subsequently emit the red light, blue light, and green light respectively associated with the individual red, blue, and green fluorescent materials in the phosphor layer. By combining appropriate ratios of red, blue, and green fluorescent materials in the phosphor layer, a white light is generated.

### BACKGROUND OF THE INVENTION

1. Field of the Invention

The present invention relates generally to a backlight module, and in particular to a backlight module having a phosphor layer and a liquid crystal display (LCD) device using the same.

2. The Prior Arts

The LCD device is not a spontaneous emitting device, so that it reproduces an image by the light of an external light source, and therefore most of the LCD devices are equipped with a backlight module as their light sources. The backlight module, usually based on a point light source or a linear light source, provides uniform light and clears viewing of displayed images.

Generally, the backlight module can be front light type or a back light type. Depending on the structure, backlight modules can be divided into three types, i.e. an edge type, a direct type, and a hollow type.

(1) An edge type structure:

The lamp tube is typically arranged on one edge side of the LCD device. The light guide plates are usually manufactured by the non-printing method. The advantages for a 18-inch LCD with an edge type backlight module are that it is slim and light, power saving and low radiation. The LCD devices with the edge type backlight modules have been widely used in various types of electronic products such as mobile phones, personal digital assistant (PDA), notebook computers, digital cameras, video cameras, and the like.

(2) A direct type structure:

Direct type backlight modules are typically used in large sized LCDs. Because the edge type structure cannot take advantages on the weight, power saving, and brightness, the direct type structure having a plurality of lamp tubes located below the diffusion plate and not including the light guide plate is developed up. The direct type backlight modules are suitable to be used in the LCD monitor and LCD TV not demanding in the portability and small size.

(3) A hollow type structure:

Large sized LCDs are developed up with an increase in image size. Because LCD monitor and wall-hanging TV require a big screen, high brightness, light weight, and low heat produced under high power, a hollow type structure is developed up to meet the above-mentioned requirements.

Generally, the backlight module comprises six components as follows:

1. A Light Source

The light source has the features of high brightness and long-life. Cold cathode fluorescent lamps (CCFLs), light emitting diodes (LEDs), and electroluminescent displays are used as the light source. However, the cold cathode fluorescent lamps have the advantages of high brightness, high efficiency, long life and excellent color rendering, and have a cylindrical shape, and the cold cathode fluorescent lamps having a cylindrical shape are suitable to be combined with the reflection element to form a thin plate light-emitting device. Therefore, the cold cathode fluorescent lamps are still the mainstream light sources.

2. A Light Guide Plate

The light guide plats which is an element for improving the light emission efficiency are usually applied to the edge type backlight modules. The light guide plate is made of a transparent organic resin, such as polymethyl methacrylate (PMMA), and has a lower surface forming circular, hexagonal or square granular patterns by a screen printing or injection method to serve as diffusion dots. The light guide plate is used for guiding light from the light source to the main display screen and the sub-display screen.

3. A Reflective Plate

The reflecting plate is located below the light guide plate to reflect light emitted from the lamp tube into the light guide plate and to increase the utilization efficiency of the backlight module.

4. A Diffusion Plate

The diffusion plate is formed on an upper surface of the light guiding platen, and is used for improving uniformity of brightness and. The diffusion plate is made of a material which is capable of scattering. When the light passes through the diffusion plate, it will be refracted, reflected, and scattered for many times to achieve the diffusion effect.

5. A Prism Sheet

The prism sheet can increase the efficiency of backlighting by directing the light angle in the optimum direction using the fine configuration of the prism. When using a prism sheet, the brightness of the LCD device can be increased up to 60% to 100%.

6. A Polarization Converter

The polarization converter is capable of interchanging polarized states of light. The conventional polarization plate transmits light having a polarization oriented parallel to the bars and to define a transmitted light corresponding to the light as P-ray, and to reflect light having a polarization oriented perpendicular to the bars and to define a reflected light corresponding to the light as S-ray. Therefore, the luminous efficiency is very poor in the prior art. In order to solve the above-mentioned problem, the polarization converter is used to improve the luminous efficiency.

In the LED industry, the white light-emitting diodes are usually blue InGaN LEDs with a coating of a suitable phosphor. Cerium(III)-doped YAG (YAG:Ce³⁺, or Y₃Al₅O₁₂:Ce³⁺) is often used; it absorbs the light from the blue LED and emits in a broad range from greenish to reddish, with most of output in yellow. The pale yellow emission of the Ce³⁺:YAG can be tuned by substituting the cerium with other rare earth elements such as terbium and gadolinium and can even be further adjusted by substituting some or all of the aluminium in the YAG with gallium. The white LEDs can also be made by coating near ultraviolet (NUV) emitting LEDs with a mixture of high efficiency europium based red and blue emitting phosphors plus green emitting copper and aluminium doped zinc sulfide (ZnS:Cu,Al).

### SUMMARY OF THE INVENTION

The objective of the present invention is to provide a backlight module having a phosphor layer and a liquid crystal display device using the backlight module as its light source, wherein the phosphor consisting of a plurality of fluorescent materials can be excited by the blue light or the ultraviolet light, and the excited phosphor states subsequently emit the red light, blue light, and green light respectively associated with the individual red, blue, and green fluorescent materials in the phosphor layer. By combining appropriate ratios of red, blue, and green fluorescent materials in the phosphor layer, a white light is generated.

To achieve the foregoing objective, the present invention provides a backlight module having a phosphor layer and a liquid crystal display device using the same. The backlight module includes a bottom cover, a plurality of light sources (which can emit a blue light or an ultraviolet light) installed inside of the bottom cover, a diffusion plate, and a multicolor phosphor layer formed on a surface of the diffusion plate.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIGS. 1A to 1G is a schematic view of a backlight module having a phosphor layer using a blue light source according to the present invention;

FIGS. 2A to 2D are the schematic view of the backlight module having a phosphor layer using an ultraviolet light source according to one embodiment of the present invention;

FIGS. 3A and 3B are the schematic view of the backlight module having a phosphor layer using the ultraviolet light according to another embodiment of the present invention;

FIGS. 4A to 4C are the schematic view of the formation of the multicolor phosphor layer; and

FIGS. 5A and 5B are the schematic view of the LCD device.

### DETAILED DESCRIPTION OF THE PREFERRED EMBODIMENT

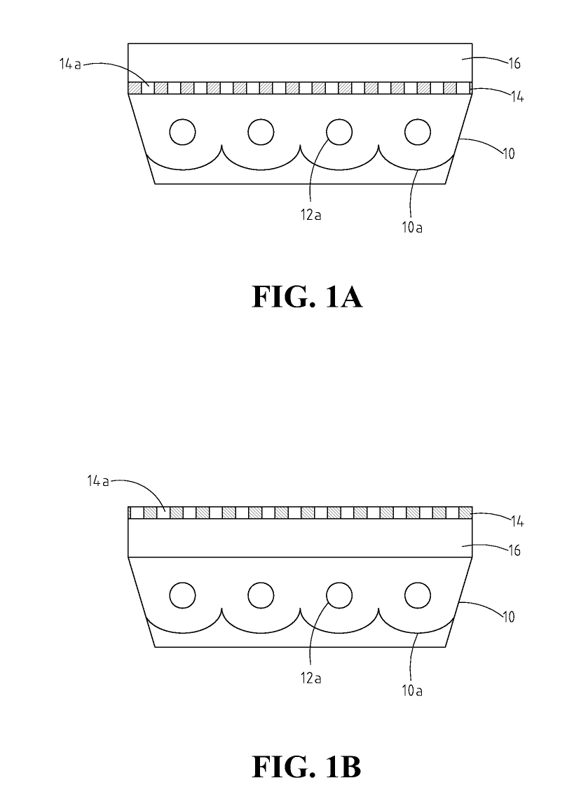

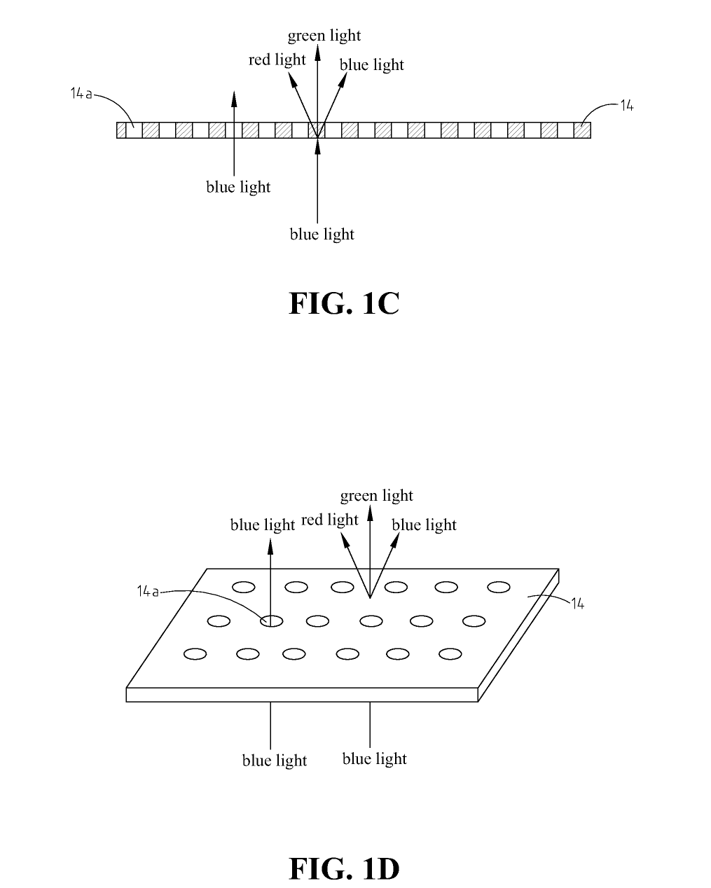

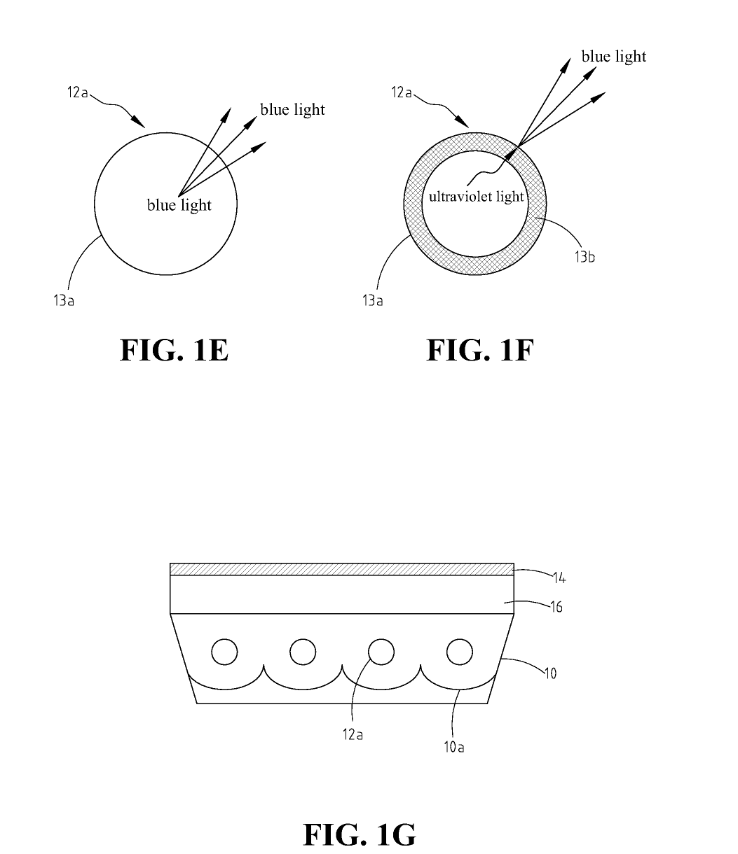

FIGS. 1A to 1G is a schematic view of a backlight module having a phosphor layer using a blue light source according to the present invention. Referring to FIGS. 1A to 1C, the backlight module having a phosphor layer according to the present invention includes a bottom cover 10, a plurality of light sources (such as the blue light sources 12a shown in FIGS. 1A and 1B) installed inside of the bottom cover 10, a diffusion plate 16, and a multicolor phosphor layer 14. The light sources can be cold cathode fluorescent lamps (CCFL), or light emitting diodes (LED). The diffusion plate 16 includes an upper surface and a lower surface. The lower surface of the diffusion plate 16 is coated with a multicolor phosphor layer 14 as shown in FIG. 1A. In another case, the upper surface of the diffusion plate 16 is coated with a multicolor phosphor layer 14 as shown in FIG. 1B.

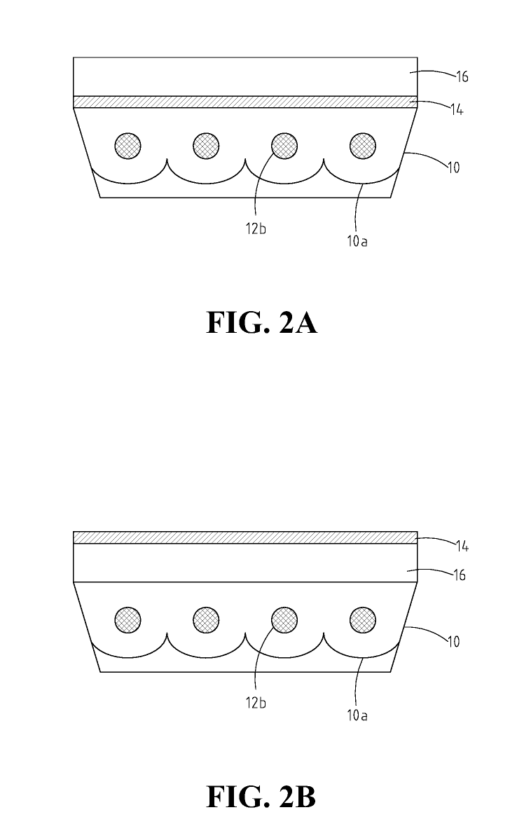

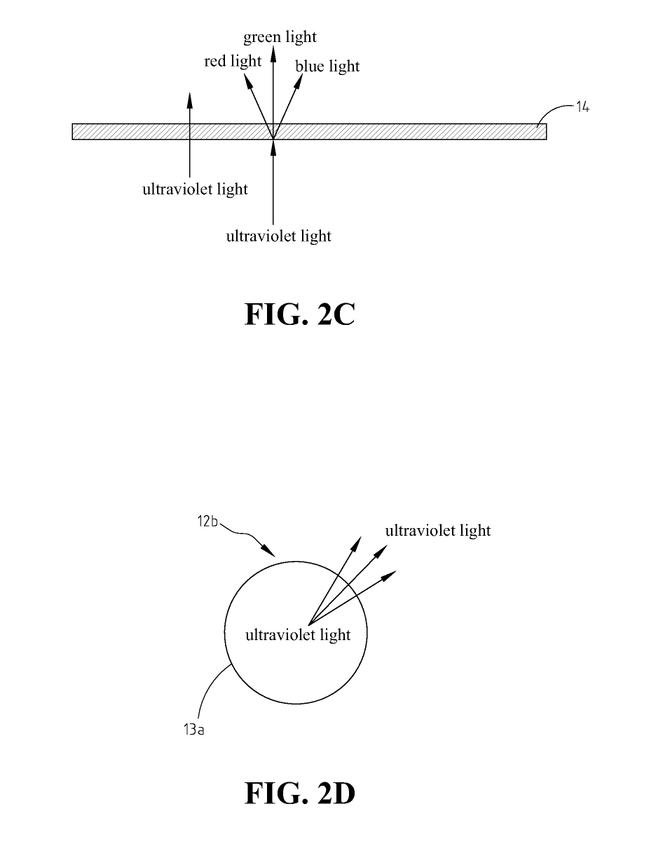

In this embodiment, the multicolor phosphors consisting of red, and green fluorescent materials can be excited by the blue light emitted from the blue light sources 12a. Alternatively, the multicolor phosphors consisting of red, green, and blue fluorescent materials can be excited by the ultraviolet light emitted from the ultraviolet light sources 12b, and the excited phosphor states subsequently emit the red light, blue light, and green light respectively associated with the individual red, blue, and green fluorescent materials. By combining appropriate ratios of red, blue, and green fluorescent materials and mixing light colors emitted by them together, a white light is generated. There can be two types of the blue light sources 12a as shown in FIG. 1E and FIG. 1F. In one case, the blue light is directly emitted from the blue light sources through the glass tube 13a as shown in FIG. 1E. In another case, the blue light is emitted from the phosphor coating 13b provided on the surface of the glass tube 13a with an ultraviolet light source therein. However, the ultraviolet light only can be directly emitted from the blue light sources 12b through the glass tube 13a as shown in FIG. 2D.

As shown in FIGS. 1A and 1B, the multicolor phosphor layer 14 is excited by the light emitted from the blue light sources 12a maintaining a substantially constant luminous efficiency and converts a significant portion to red and green light with constant luminous quantity. By changing the ratio of the blue light passing through the multicolor phosphor layer 14, a desired color by mixing the red, green, and blue lights in an appropriate ratio can be achieved. Although the ratio of the blue light passing through the multicolor phosphor layer 14 depends on the thickness of the multicolor phosphor layer 14, the thicknesses of the commercially available multicolor phosphor layers are constant. Therefore, only the ratio of the blue light which directly passes through the multicolor phosphor layer 14 via the throughholes 14a can be changed. As shown in FIGS. 1D and 1E, the ratio of the blue light which passes through the multicolor phosphor layer 14 can be adjusted by changing the area ratio of the throughholes 14a to that of the whole multicolor phosphor layer 14. The formation of the throughholes can be carried out using a variety of processing methods such as etching, drill-based mechanical processing, and the like. If the diffusion plate 16 is thin enough, the amount of blue light passing through the multicolor phosphor layer 14 will be increased as shown in FIGS. 1D and 1E. Therefore, in order to obtain the desired color, the ratio of the blue light which passes through the multicolor phosphor layer 14 can be adjusted by changing the thickness of the diffusion plate 16 without the formation of throughholes 14a on the multicolor phosphor layer 14 as shown in FIGS. 1G.

FIGS. 2A to 2D are the schematic view of the backlight module having a phosphor layer using the ultraviolet light according to one embodiment of the present invention. Referring to FIGS. 2A to 2D, the backlight module having a phosphor layer according to the present invention includes a bottom cover 10, a plurality of light sources (such as the ultraviolet light sources 12b shown in FIGS. 2A and 2B) installed inside of the bottom cover 10, a diffusion plate 16, and a multicolor phosphor layer 14. The ultraviolet light sources can be cold cathode fluorescent lamps (CCFL), or light emitting diodes (LED). The diffusion plate 16 has an upper surface and a lower surface. The lower surface of the diffusion plate 16 is coated with a multicolor phosphor layer 14 as shown in FIG. 2A. In another case, the upper surface of the diffusion plate 16 is coated with a multicolor phosphor layer 14 as shown in FIG. 2B.

In this embodiment, As shown in FIGS. 2A to 2D, the multicolor phosphor layer 14 is excited by the light emitted from the ultraviolet light sources 12b maintaining a substantially constant luminous efficiency and converts a significant portion to red, green and blue lights with constant luminous quantity. By changing the ratios of the red, green and blue fluorescent material, a desired color by mixing the red, green, and blue lights in an appropriate ratio can be achieved. If the multicolor phosphor layer 14 is thin enough, the portions of the ultraviolet light will pass through the multicolor phosphor layer 14 as shown in FIG. 2C. In order to enhance the brightness of LED, the ultraviolet light will be filtered out and cannot pass through the multicolor phosphor layer 14.

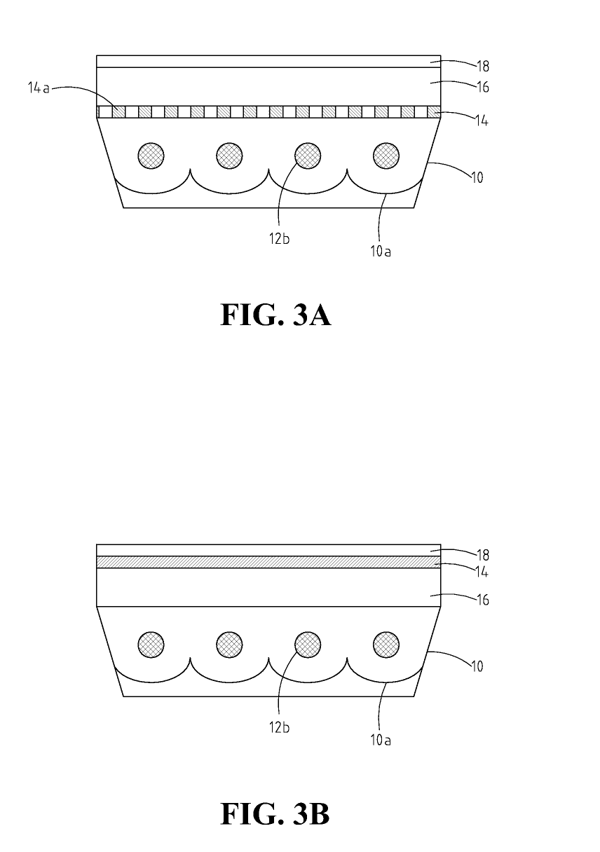

FIGS. 3A and 3B are the schematic view of the backlight module having a phosphor layer using the ultraviolet light according to another embodiment of the present invention. Referring to FIGS. 3A and 3B, the backlight module having a phosphor layer according to the present invention includes an ultraviolet light filter film 18 in addition to a bottom cover 10, a plurality of light sources (such as the ultraviolet light sources 12b shown in FIGS. 3A and 3B) installed inside of the bottom cover 10, a diffusion plate 16, a multicolor phosphor layer 14.

The ultraviolet light filter film 18 in the backlight module having a phosphor layer according to the present invention can be utilized with the multicolor phosphor layer 14 with or without the presence of throughholes on the multicolor phosphor layer 14 (respectively shown in FIGS. 3A and 3B) so that the ultraviolet light emitted from the ultraviolet light sources 12b can be filtered out by the ultraviolet light filter film 18 and cannot escape out of the backlight module, and when the emitted ultraviolet light is reflected back by the a reflecting plate 10a, it can excite the multicolor phosphor layer 14 again.

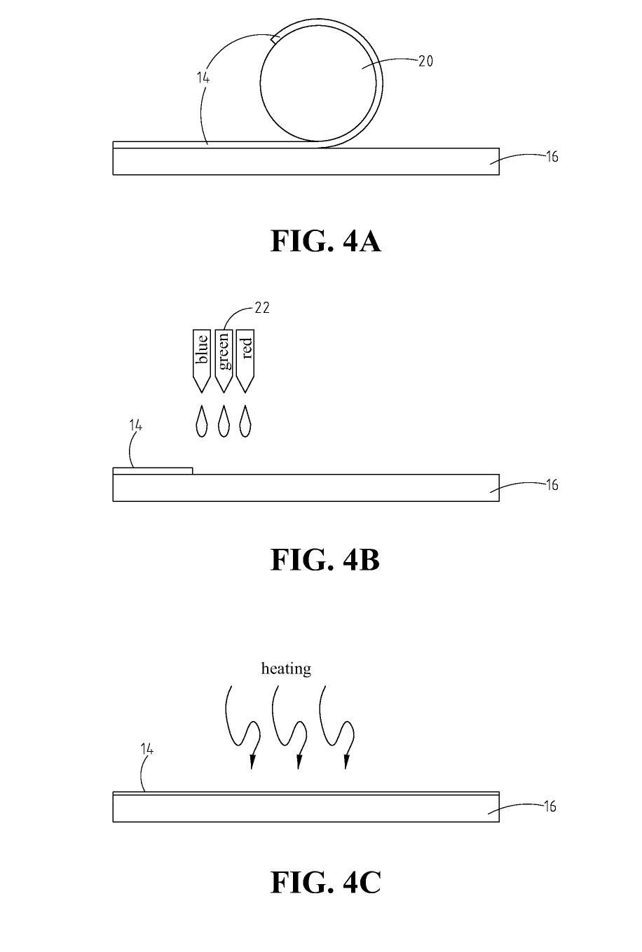

FIGS. 4A to 4C are the schematic view of the formation of the multicolor phosphor layer. Referring to FIGS. 4A to 4C, the multicolor phosphor layer 14 is applied to the diffusion plate 16 by a number of existing techniques, such as roll printing using the roll feeder 20 (as shown in FIG. 4A), or spraying using multiple nozzles 22 (as shown in FIG. 4B). Alternatively, the multicolor phosphor layer 14 is applied to the diffusion plate 16 by polymerizing the transparent polymer and the fluorescent material under heating or ultraviolet light irradiation as shown in FIG. 4C. However, it is not necessary for the multicolor phosphor layer 14 to be directly applied to the diffusion plate 16. The transparent polymer and the fluorescent material can be polymerized to form a film on a substrate under heating or ultraviolet light irradiation, and then the formed film is attached to the diffusion plate 16.

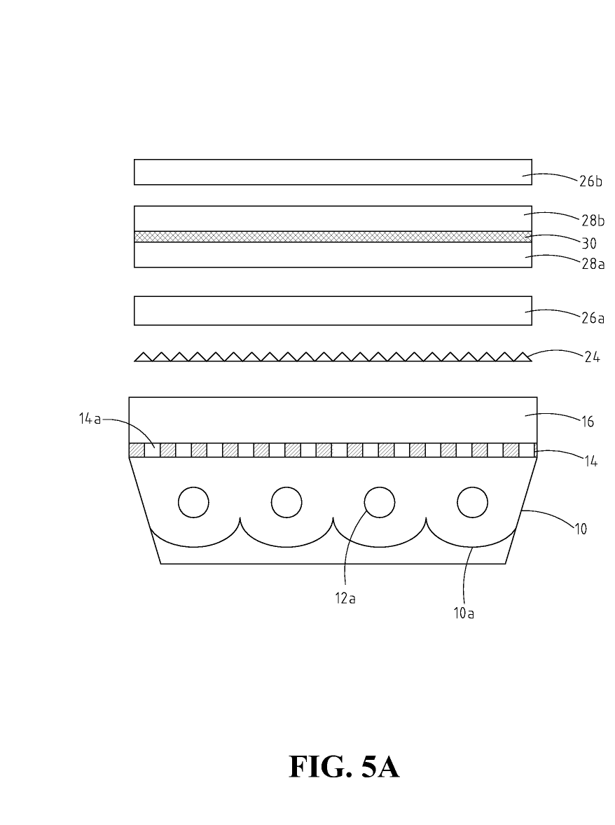

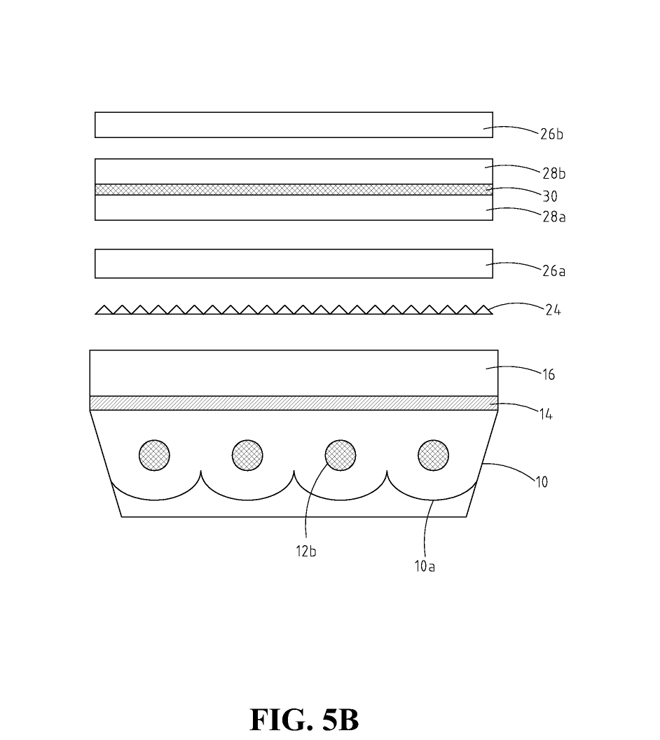

FIGS. 5A and 5B are the schematic view of the LCD device. Referring to FIGS. 5A and 5B, the LCD device of the present invention includes a backlight module having a phosphor layer as above mentioned, a liquid crystal cell 30 sandwiched between the upper glass substrate 28b and the lower glass substrate 28a, a top and a bottom polarization plates 26b, 26a disposed respectively above the upper glass substrate 28b and below the lower glass substrate 28a, and a prism layer 24 disposed between the backlight module and the bottom polarization plate 26a, wherein the backlight module having a phosphor layer includes a bottom cover 10, a plurality of light sources (such as the blue light sources 12a shown in FIGS. 1A and 1B, and the ultraviolet light sources 12b shown in FIGS. 2A and 2B) installed inside of the bottom cover 10, a diffusion plate 16, and a multicolor phosphor layer 14.

It will be apparent to those skilled in the art that various modifications and variations can be made in the present invention without departing from the spirit or scope of the present invention. Thus, it is intended that the present invention cover the modifications and the variations of this invention provided they come within the scope of the appended claims and their equivalents.

What is claimed is:

1. A backlight module having a phosphor layer, comprising:
a bottom cover;
a plurality of light sources emitting a blue light or an ultraviolet light and installed inside of the bottom cover;
a diffusion plate having an upper surface and a lower surface and disposed above the light sources for diffusing light emitted from the light sources to produce uniform light; and
a multicolor phosphor layer consisting of a plurality of fluorescent materials being mixed in a predetermined ratio and disposed on one of the surfaces of the diffusion plate.

2. The backlight module as claimed in claim 1, wherein the light sources are cold cathode fluorescent lamps, or light emitting diodes.

3. The backlight module as claimed in claim 1, wherein the multicolor phosphor layer is disposed on the lower surface of the diffusion plate.

4. The backlight module as claimed in claim 1, wherein the multicolor phosphor layer is disposed on the upper surface of the diffusion plate.

5. The backlight module as claimed in claim 1, further comprising an ultraviolet light filter film disposed above the diffusion plate for filtering out of an ultraviolet light emitted from the light sources and preventing the ultraviolet light from escaping out of the backlight module.

6. The backlight module as claimed in claim 1, wherein the multicolor phosphor layer has a plurality of throughholes formed thereon, and a ratio of the blue light passing through the multicolor phosphor layer is adjusted by changing an area ratio of the throughholes to that of the multicolor phosphor layer so that the desired light color is obtained.

7. The backlight module as claimed in claim 1, wherein the multicolor phosphor layer is applied to the diffusion plate by roll printing.

8. The backlight module as claimed in claim 1, wherein the multicolor phosphor layer is applied to the diffusion plate by spraying.

9. The backlight module as claimed in claim 1, wherein the multicolor phosphor layer is applied to the diffusion plate by polymerizing the transparent polymer and the fluorescent material under heating.

10. A liquid crystal display device, comprising:
a backlight module including a bottom cover, a plurality of light sources emitting a blue light or an ultraviolet light and installed inside of the bottom cover, a diffusion plate disposed above the light sources for diffusing light emitted from the light sources to produce uniform light, and a multicolor phosphor layer consisting of a plurality of fluorescent materials being mixed in a predetermined ratio and disposed on a surface of the diffusion plate;
a liquid crystal cell sandwiched between an upper glass substrate and a lower glass substrate;
a top and a bottom polarization plates disposed respectively above the upper glass substrate and below the lower glass substrate; and
a prism layer disposed between the backlight module and the bottom polarization plate.
